(19) United States
(12) Patent Application Publication
(10) Pub. No.: US 2015/0302471 A1
(43) Pub. Date: Oct. 22, 2015

(54) BENCHMARKING IN ONLINE ADVERTISING

(71) Applicant: Kenshoo Ltd., Tel Aviv (IL)

(72) Inventors: Gilad Armon, Amirim (IL); Adiel Loinger, Givat Shmuel (IL); Uri Blatt, Tel Aviv (IL); Shahar Siegman, Tel Aviv (IL)

(21) Appl. No.: 14/258,295

(22) Filed: Apr. 22, 2014

(51) Int. Cl. G06Q 30/02

(52) U.S. Cl. CPC G06Q 30/0254

(57) ABSTRACT

A method for benchmarking in online advertising, the method comprising using at least one hardware processor for: comparing values of a metric associated with a first online ad entity to values of the same metric associated with other online ad entities; and based on the comparing, identifying one or more of the other online ad entities as potential benchmarks to the first online ad entity. In addition, a method for benchmarking in online advertising, the method comprising using at least one hardware processor for: comparing values of N metrics associated with M online ad entities, wherein N≧1 and M≧2; based on the comparing, constructing an N×M×M matrix indicative of statistical relationships between the M online ad entities over the N metrics; and clustering cells of the matrix, to produce multiple clusters each comprised of similarly-characterized cells, whereby each of the multiple clusters is usable as a joint benchmark.

### FIELD OF THE INVENTION

Present embodiments relate to the field of online advertising.

### BACKGROUND

Advertising using traditional media, such as television, radio, newspapers and magazines, is well known. Unfortunately, even when armed with demographic studies and entirely reasonable assumptions about the typical audience of various media outlets, advertisers recognize that much of their advertising budget is oftentimes simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their advertisements (also “ads”) to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif., delivers ads targeted to keywords from search queries. Similarly, content-targeted ad delivery systems have been proposed. For example, U.S. Pat. No. 7,716,161 to Dean et al. and U.S. Pat. No. 7,136,875 to Anderson et al. describe methods and apparatuses for serving ads relevant to the content of a document, such as a web page. Content-targeted ad delivery systems, such as the AdSense advertising system by Google for example, have been used to serve ads on web pages.

AdSense is part of what is often called advertisement syndication, which allows advertisers to extend their marketing reach by distributing advertisements to additional partners. For example, third party online publishers can place an advertiser's text or image advertisements on web pages that have content related to the advertisement. This is often referred to as “contextual advertising”. As the users are likely interested in the particular content on the publisher web page, they are also likely to be interested in the product or service featured in the advertisement. Accordingly, such targeted advertisement placement can help drive online customers to the advertiser's website.

Optimal ad placement has become a critical competitive advantage in the Internet advertising business. Consumers are spending an ever-increasing amount of time online, looking for information. The information, provided by Internet content providers, is viewed on a page-by-page basis. Each page can contain written and graphical information as well as one or more ads. Key advantages of the Internet, relative to other information media, are that each page can be customized to fit a customer profile and ads can contain links to other Internet pages. Thus, ads can be directly targeted at different customer segments. For example, ad targeting is nowadays possible based on the geographic location of the advertiser and/or the customer, the past navigation path of the customer outside or within the web site, the language used by the visitor's web browser, the purchase history on a website, the behavioral intent influenced by the user's action on the site, and more.

Furthermore, the ads themselves are often designed and positioned to form direct connections to well-designed Internet pages. The concept referred to as “native advertising” offers ads which more naturally blend into a page's design, in cases where advertiser's intent is to make the paid advertising feel less intrusive and, therefore, increase the likelihood users will click on it.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment relates to a method for benchmarking in online advertising, the method comprising using at least one hardware processor for: comparing values of a metric associated with a first online ad entity to values of the same metric associated with other online ad entities; and based on the comparing, identifying one or more of the other online ad entities as potential benchmarks to the first online ad entity.

Another embodiment relates to a computer program product for benchmarking in online advertising, the computer program product comprising a non-transitory computer-readable storage medium having program code embodied therewith, the program code executable by at least one hardware processor for: comparing values of a metric associated with a first online ad entity to values of the same metric associated with other online ad entities; and based on the comparing, identifying one or more of the other online ad entities as potential benchmarks to the first online ad entity.

In some embodiments, the comparing comprises: receiving a first historical time series comprising the values of the metric associated with the first online ad entity; receiving multiple other historical time series comprising the values of the metric associated with the other online ad entities; and computing a set of statistical relationships, each of the statistical relationships being between the first historical time series and a different one of the multiple other historical time series.

In some embodiments, the statistical relationships are Pearson correlations.

In some embodiments, the identifying comprises: based on the computing of the set of statistical relationships, selecting a specific one of the other online ad entities to serve as a potential benchmark to the first online ad entity, wherein the selecting is upon determining that a strongest one of the statistical relationships is between the first historical time series and one of the multiple other historical time series which comprises the values of the metric associated with the specific one of the other online ad entities.

In some embodiments, the identifying comprises: based on the computing of the set of statistical relationships, selecting a specific subset of the other online ad entities to serve as a potential benchmark to the first online ad entity, wherein the selecting is upon determining that strongest ones of the statistical relationships are between the first historical time series and the subset of the multiple other historical time series which comprises the values of the metric associated with the specific subset of the other online ad entities.

In some embodiments, the method further comprises: computing a statistical measure of the values of the metric associated with the specific subset of the other online ad entities; and defining the statistical measure as a benchmark to the values of the metric associated with the first online ad entity.

In some embodiments, the statistical measure is selected from the group consisting of: an average, a mean and a mode.

In some embodiments, the first online ad entity and the other online ad entities are each selected from the group consisting of: a campaign, a group of campaigns, an individual ads and a group of individual ads.

In some embodiments, the program code is further executable by the at least one hardware processor for: computing a statistical measure of the values of the metric associated with the specific subset of the other online ad entities; and defining the statistical measure as a benchmark to the values of the metric associated with the first online ad entity.

A further embodiment relates to a method for benchmarking in online advertising, the method comprising using at least one hardware processor for: comparing values of N metrics associated with M online ad entities, wherein N≧1 and M≧2; based on the comparing, constructing an N×M×M matrix indicative of statistical relationships between the M online ad entities over the N metrics; and clustering cells of the matrix, to produce multiple clusters each comprised of similarly-characterized cells, whereby each of the multiple clusters is usable as a joint benchmark.

Another embodiment relates to a computer program product for benchmarking in online advertising, the computer program product comprising a non-transitory computer-readable storage medium having program code embodied therewith, the program code executable by at least one hardware processor for: comparing values of N metrics associated with M online ad entities, wherein N≧1 and M≧2; based on the comparing, constructing an N×M×M matrix indicative of statistical relationships between the M online ad entities; and clustering cells of the matrix, to produce multiple clusters each comprised of similarly-characterized cells, whereby each of the multiple clusters is usable as a joint benchmark.

In some embodiments, different ones of the multiple clusters are associated with advertisers belonging to different business sectors.

In some embodiments, the comparing comprises: receiving multiple historical time series comprising the values of the N metrics associated with the M online ad entities; and computing N·M² statistical relationships, each of the statistical relationships being between members of a different pair of the multiple historical time series.

In some embodiments, the statistical relationships are Pearson correlations.

In some embodiments, N≧2. In some embodiments, N≧3.

In some embodiments, the method further comprises using the at least one hardware processor for displaying the matrix on a computer screen, wherein strengths of the statistical relationships are displayed numerically.

In some embodiments, the method further comprises using the at least one hardware processor for displaying the matrix on a computer screen, wherein strengths of the statistical relationships are displayed using different colors.

In some embodiments, the program code is further executable by the at least one hardware processor for displaying the matrix on a computer screen, wherein strengths of the statistical relationships are displayed numerically

In some embodiments, the program code is further executable by the at least one hardware processor for displaying the matrix on a computer screen, wherein strengths of the statistical relationships are displayed using different colors.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. It is intended that the embodiments and figures disclosed herein are to be considered illustrative rather than restrictive. The figures are listed below.

FIG. 1 shows a schematic of an exemplary a cloud computing node;

FIG. 2 shows an illustrative cloud computing environment;

FIG. 3 shows a set of functional abstraction layers provided by the cloud computing environment;

FIG. 4 shows a flow chart of a benchmarking method;

FIG. 5 shows a flow chart of another benchmarking method; and

FIG. 6 shows an illustration of an exemplary heat map.

### DETAILED DESCRIPTION

Disclosed herein are benchmarking methods and computer program products employing the same, which are usable in the online advertising field. Based on these methods, an advertiser, or any entity acting on behalf of the advertiser, may gain significant insight as to how a certain ad entity of the advertiser compares to a relevant benchmark. Merely as an example, an advertiser which runs a certain ad over time and observes its performance, may usually lack any knowledge on whether this performance is above, below or within the average of similarly-characterized ads of other advertisers or even of the same advertiser. Using the present method, however, this advertiser may be able to conveniently compare its ad performance to a benchmark, which is computed in an advantageous manner ensuring its relevancy and applicability to the advertiser's ad.

Furthermore, and in accordance with some embodiments, one or multiple actions may be carried out automatically based on the comparison of the ad entity to the computed benchmark. For example, if a certain performance metric of the ad entity is below or above the benchmark, an advertising platform which runs the ad entity may be communicated with, in order to affect that certain performance metric. The advertiser may pre-define whether such actions are to be carried out completely automatically, or require its consent on a case-by-case basis.

Further yet, in accordance with some embodiments, a many-to-many analysis of ad entities may be conducted, to enable a detection of clusters of similarly-characterized statistical relationships between at least some of these ad entities. This may include a construction of a matrix out of the statistical relationships between one or more performance metrics of the ad entities. Then, the matrix may be arranged in an advantageous manner, which enables its clustering. Each of the resulting clusters may serve as a joint benchmark, indicative of the common performance of the ads included in that cluster. In some scenarios, different ones of the clusters may be associated with advertisers belonging to different business sectors. This may occur naturally; namely, it is likely that ad entities whose performance metrics behave similarly are related to the same business sector. Optionally, the matrix may be rendered visually and displayed on a computer screen, such that a user may observe the clusters and/or the statistical relationships between at least some of the ad entities. The visualizing, in some embodiments, may be in the form of a color-coded heat map.

### Glossary

“Online advertising platform” (or simply “advertising platform”): This term, as referred to herein, may relate to a service offered by an advertising business to different advertisers. In the course of this service, the advertising business serves ads, on behalf of the advertisers, to Internet users. Each advertising platform usually services a large number of advertisers, who compete on advertising resources available through the platform. The competition is oftentimes carried out by conducting some form of an auction, where advertisers bid on advertising resources. The ads may be displayed (and/or otherwise presented) in various web sites which are affiliated with the advertising business (these web sites constituting what is often referred to as a “display network”) and/or in one or more web sites operated directly by the advertising business.

AdWords, a service operated by Google, Inc. of Mountain View, Calif., is a prominent example of an advertising platform. In AdWords, advertisers can choose between displaying their ads in a display network and/or in Google's own search engine; the former involves the subscription of web site operators (often called “publishers”) to Google's AdSense program, whereas the latter, often referred to as SEM (Search Engine Marketing), involves triggering the displaying of ads based on keywords entered by users in the search engine.

A further type of advertising platforms, commonly referred to as a “social” advertising platform, involves the displaying of ads to users of online social networks. An online social network is often defined as a set of dyadic connections between persons and/or organizations, enabling these entities to communicate over the Internet. In social advertising, both the advertisers and the users enjoy the fact that the displayed ads can be highly tailored to the users viewing them. This feature is enabled by way of analyzing various demographics and/or other parameters of the users—parameters which are readily available in many advertising platforms of social networks and are usually provided by the users themselves. Facebook Ads, operated by Facebook, Inc. of Menlo Park, Calif., is such an advertising platform. LinkedIn Ads, by LinkedIn Corporation of Mountain View, Calif., is another.

“Online ad entity” (or simply “ad entity”): This term, as referred to herein, may relate to an individual ad, or, alternatively, to a set of individual ads, run by an advertising platform. An individual ad, as referred to herein, may include an ad copy, which is the text, graphics and/or other media to be served (displayed and/or otherwise presented) to users. In addition, an individual ad may include and/or be associated with a set of parameters, such as searched keywords to target, geographies to target, demographics to target, a bid for utilization of advertising resources of the advertising platform, and/or the like. Sometimes, the bid may set for a particular parameter instead of or in addition to setting a global bid for the ad entity; for example, a bid may be per keyword, geography, etc.

To aid advertisers in neatly organizing their ads, advertising platforms often allow grouping individual ads in sets, such as the “AdGroups” feature in Google AdWords. The advertiser may decide on the logic behind such grouping, but it is common to have ads grouped by similar ad copies, similar targeting, etc. Advertising platforms may allow an even more abstract way to group ads; this is often called a “campaign”. A campaign usually includes multiple sets of ads, with each set including multiple ads.

“Performance”: This term, as referred to herein with regard to an ad, may relate to various statistics gathered in the course of running the ad. A “running” phase of the ad may refer to a duration in which the ad was served to users, or at least to a duration during which the advertiser defined that the ad should be served. The term “performance” may also relate to an aggregate of various statistics gathered for a set of ads, a campaign, etc. The statistics may include multiple parameters (also “metrics”). Exemplary metrics are:
“Impressions”: the number of times the ad has been served to users;
“Reach”: the number of unique users who have been exposed to the ad. This differs from “impressions” in that the reach metric does not increase when the same user is exposed to the same ad multiple times, whereas the impressions metric does. The reach metric is very common in social advertising platforms;
“Frequency”: the number of times a certain user has been exposed to the same ad. This metric is very common in social advertising platforms;
“Clicks”: the number of times users clicked (or otherwise interacted with) the ad entity;
“Cost per click (CPC)”: the average cost of a click (or another interaction with an ad entity) to the advertiser;
“Cost per impression”: the average cost of an impression to the advertiser;
“Click-through rate (CTR)”: the ratio between clicks and impressions of the ad entity, namely—the number of clicks divided by the number of impressions;
“Conversions”: the number of times in which users who clicked (or otherwise interacted with) the ad entity have consecutively accepted an offer made by the advertiser. For examples, users who purchased an advertised product, users who subscribed to an advertised service, or users who filled in their details in a lead generation form;
“Return on investment (ROI)” or “Return on advertising spending (ROAS)”: the ratio between the amount of revenue generated as a result of online advertising, and the amount of investment in those online advertising efforts. Namely—revenue divided by expenses;
“Revenue per click”: the average amount of revenue generated to the advertiser per click (or another interaction with an ad entity). This may be calculated as a function of the clicks, conversions and the advertiser's average revenue per conversion;
“Revenue per impression”: the average amount of revenue generated to the advertiser per impression of the ad entity. This may be calculated as a function of the impressions, conversions, and the advertiser's average revenue per conversion;

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

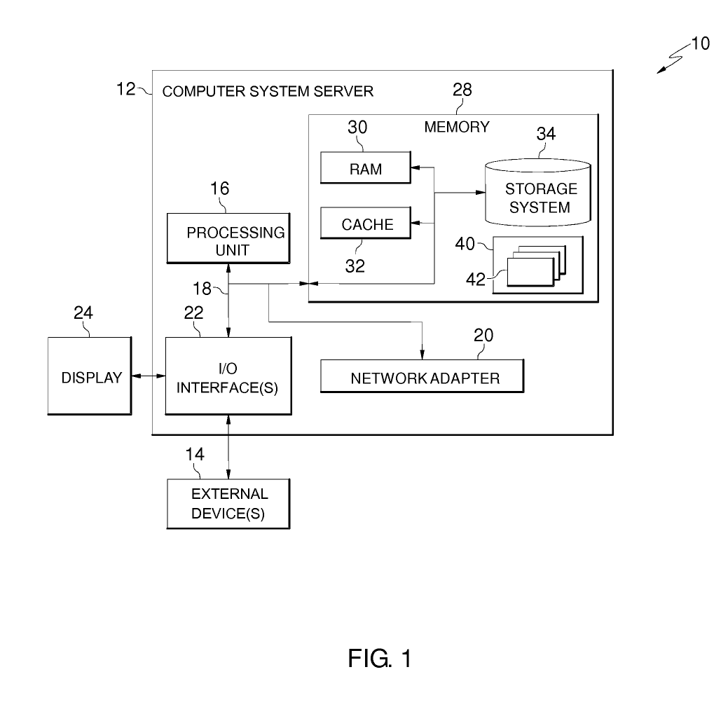

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system.

Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

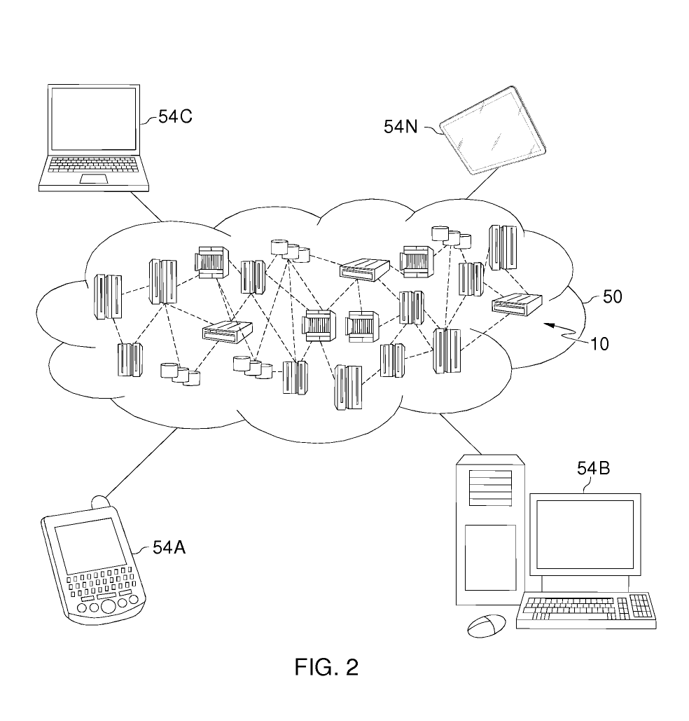

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone MA, desktop computer MB, laptop computer MC, and/or tablet computing device MN may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices MA-N shown in FIG. 2 are intended to be illustrative only and that computing nodes 10 and cloud computing environment 50 can communicate with any type of computerized device over any type of network and/or network addressable connection (e.g., using a web browser).

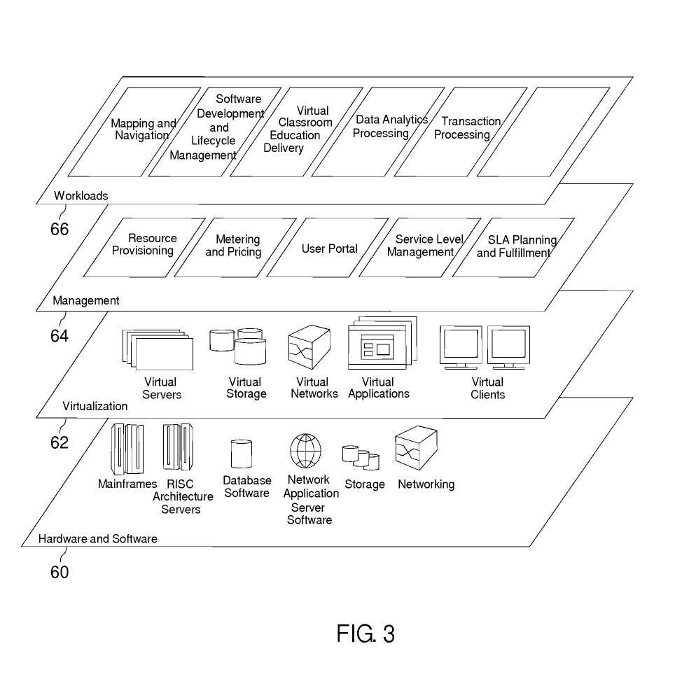

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, RISC (Reduced Instruction Set Computer) architecture based servers; storage devices; networks and networking components. Examples of software components include network application server software; and database software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; and data analytics processing; transaction processing.

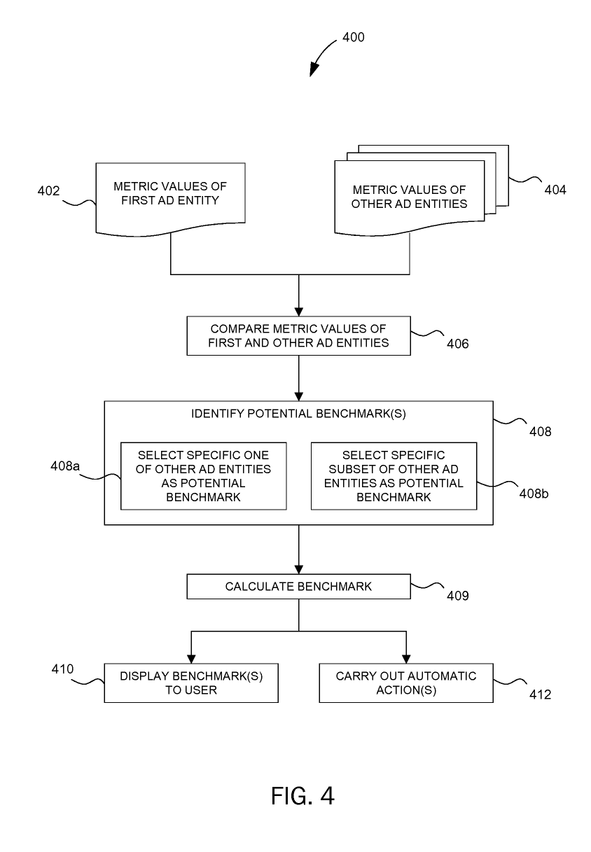

As briefly discussed above, benchmarking methods and computer program products which operate these methods are discussed herein. Reference is now made to FIG. 4, which shows a flow chart of a benchmarking method 400 usable in online advertising, in accordance with some embodiments.

Initially, input for benchmarking method 400 may be received. The input may be in the form of values of one or more metrics associated with an online ad entity (or simply “ad entity”) whose comparison to a certain benchmark is desired. For clarity purposes, this online ad entity is referred to herein as the “first” online ad entity 402. In addition, the input may include values of the same one or more metrics associated with other online ad entities 404 (or simply “ad entities”), which serve as candidate benchmarks.

Optionally, the values received in association with the first ad entity are in the form of a first historical time series which contains the values of the one or more metrics associated with the first ad entity. The first historical time series may include data points which span over a certain duration of time, such as hours, days, weeks, months or even years. Each data point (i.e. value) indicates a numerical indication of the pertinent metric, and a time indication associated with the numerical indication. Merely as an example, a data point may indicate that 150 impressions of an ad entity occurred during Jan. 1, 2014. Graphically-speaking, that data point may be represented with a y-axis coordinate which indicates the number of impressions, and an x-axis coordinate which indicates the time.

Naturally, if values of a single metric are received, only a single time series is required to convey the values. Conversely, if values of multiple metrics are received, multiple time series may be required. Needless to say, of course, that the notion of time series is merely the acceptable mathematical manner of referring to such types of information. The information itself, as discussed above, may simply be a series of data points each indicative of a value of the metric and a time.

Optionally, the values received in association with the other ad entities 404 are, similarly, in the form of multiple, other historical time series which contain the values of the same one or more metrics, but this time those values which are associated with the other ad entities.

In a step 406, the values of the one or more metrics associated with the first ad entity 402 may be compared to the values of the same one or more metrics associated with the other ad entities 404. The comparison may include a one-to-many comparison, in which, at each iteration, the pertinent values associated with the first ad entity 402 are compared to values associated with a single one of the other ad entities 404. Generally, two types of comparisons may be possible. The first includes a comparison data point by data point, in which corresponding data points (namely, which are of the same time point) of the first historical time series and one of the other historical time series are compared. The second includes applying a curve fitting algorithm, as known in the art, on each of the first historical time series and one of the other historical time series, to produce a pair of functions. These two functions may then be mathematically compared.

Prior to the comparison, the first historical time series and the other historical time series may be normalized, such that the comparison is able to compare their shape rather than their absolute values. Namely, it is possible that the first historical time series will have very different absolute values from a certain one of the other historical time series, but, nonetheless, these two may have very similar shapes which imply a strong statistical relationship. As an alternative or in addition to normalization, the first historical time series and the other historical time series may be smoothed prior to their comparison, such as using a moving average of a certain period of time (e.g. a few days).

Optionally, the comparison of step 406 is a computation of a set of statistical relationships. Each of these statistical relationships may be between the first historical time series and a different one of the multiple other historical time series. Merely as an example, the statistical relationships may be Pearson correlations, Spearman correlations, Kendall correlations, Kruskal correlations, wavelet coherences, Szekely distance correlations, etc., as known in the art. A further possible calculation is to sum the squares of difference of two time series in every time point.

Using the Pearson correlations as an example now, these may refer to each of the first and other historical time series as a whole; namely, they may provide insight as to the similarity of the entire first historical time series to the entirety of each of the other historical time series. To this end, the time periods covered by the first and other historical time series may be the same (e.g. between Jan. 1, 2014 and Jan. 15, 2014). If the received first and other historical time series cover time periods which only partially overlap, they may undergo a preliminary step of truncating in order for them to include only the time period covered by all.

In a step 408, based on the comparison of step 406, one or more of the other ad entities may be identified as potential benchmarks to the first online ad entity. These one or more of the other ad entities may be the ones whose similarity (e.g. statistical relationship) to the first ad entity is the greatest.

Step 408 may be realized in a number of different manners. For example, it may include a first sub-step 408a, in which the aforementioned identifying is a selecting of a specific one of the other ad entities to serve as a potential benchmark. This specific ad entity may be the one having the highest degree of similarity (e.g. the strongest statistical relationship) to the first ad entity. As another example, step 408 may include a second sub-step 408b, in which the aforementioned identifying is a selecting of a specific subset of the other ad entities (hereinafter the “members” of the subsets) to serve as a potential benchmark. The subset may include multiple ones of the other ad entities which exhibit the highest degree of similarity (e.g. the strongest statistical relationship) to the first ad entity. The size of the subset may be predetermined (e.g. to include a preset number of other ad entities) or be dynamically computed, such as by defining a certain numerical threshold above which other ad entities are eligible of being included in the subset. For instance, that threshold may be a Pearson correlation value (e.g. 0.7) between the first ad entity and a certain one of the other ad entities, above which that certain one of the other ad entities enters the subset.

It should be noted that sub-steps 408a and 408b may be both carried out if desired.

If sub-step 408b is executed, then the subset of the other ad entities may undergo further calculation, in a step 409, to consolidate the other ad entities it contains into a single benchmark. This consolidation may include a computing of a statistical measure of the values of the metric associated with the subset of the other ad entities. Examples of this statistical measure may include an average (e.g. a regular average, a weighted average), a mean and a mode—but may include any other statistical measure known in the field of statistics. The computation of the statistical measure may be carried out data point by data point, applying the computation on data points of the subsets pertaining to the same point in time. Alternatively, the computation of the statistical measure may include applying a curve fitting algorithm to each of the members of the subset, as known in the art. This yields a continuous of a part-wise function for each member. Then, a statistical measure may be computed on these functions, as known in the art. Merely as an example, these functions may be averaged, to produce an average function which serves as the benchmark.

In a step 410, one, some or all of the benchmarks produced during the execution of method 400 may be displayed to a user. For example, the user may be presented with partial or complete information as to one of the other ad entities which serves as the benchmark. This may include information as to the values of the metric of that ad entity, other metrics of the ad entity, ad copy and more. Additionally or alternatively, the user may be presented with a purely numerical comparison between first ad entity 402 and the calculated benchmark or the potential benchmark (e.g. 1.5 vs. 2.5, respectively). Additionally or alternatively, the user may be presented with a visual comparison between first ad entity 402 and the calculated benchmark or the potential benchmark, for example in the form of a bars chart, a position of first ad entity 402 on a scale, a line chart, etc.

In a step 412, one, some or all of the benchmarks produced during the execution of method 400 may be utilized for carrying out one or more automatic or semi-automatic actions in an advertising platform, with respect to first ad entity 412. For example, if a certain performance metric (or other given relations between metrics over time) of the ad entity is below or above one or more of the benchmarks, an advertising platform which runs the ad entity may be communicated with (i.e. via an API), in order to affect that certain performance metric. This may include, for instance, adjusting (i.e. increasing or decreasing) one or more bids associated with first ad entity 412; adjusting (i.e. increasing or decreasing) a budget associated with first ad entity 412, etc. The advertiser may pre-define whether such actions are to be carried out completely automatically, or require its consent on a case-by-case basis.

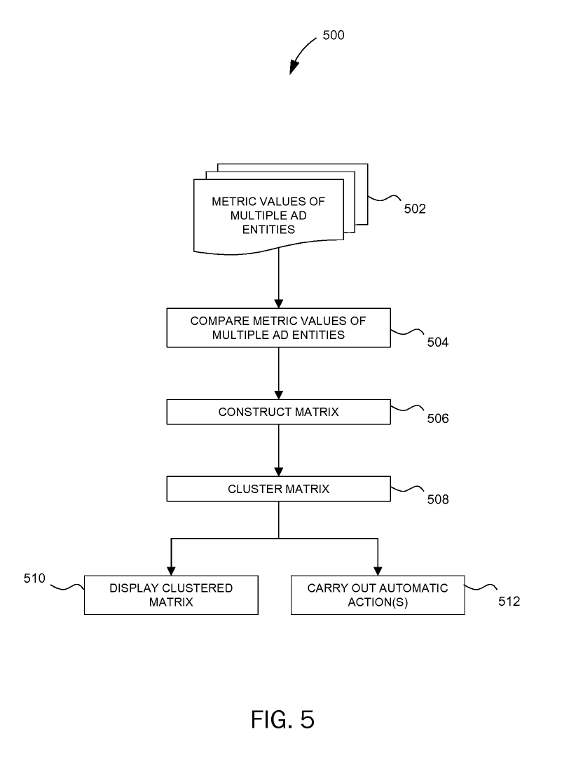

Reference is now made to FIG. 5, which shows a flow chart of another benchmarking method 500 usable in online advertising, in accordance with some embodiments. Benchmarking method 500, generally, may include a many-to-many analysis of multiple ad entities, followed by a clustering step which may be useful in identifying one or more joint benchmarks.

Initially, input for benchmarking method 500 may be received. The input may be in the form of values of one or more metrics associated with multiple online ad entities (or simply “ad entities”) 502. For purposes of this discussion, the number of the multiple online ad entities is marked M, wherein M is two or more, and the number of the metrics is marked N, wherein N is one or more.

Optionally, the values received in association with the M online ad entities are in the form of N·M historical time series, namely—N historical time series for each of the M ad entities, each associated with a different one of the M online ad entities. Each of the N·M historical time series may include data points which span over a certain duration of time, such as hours, days, weeks, months or even years. Each data point (i.e. value) indicates a numerical indication of the pertinent metric, and a time indication associated with the numerical indication. Merely as an example, a data point may indicate that 250 conversions occurred in association with a certain ad entity during Jan. 1, 2014. Graphically-speaking, that data point may be represented with a y-axis coordinate which indicates the number of impressions, and an x-axis coordinate which indicates the time.

Needless to say, of course, that the notion of time series is merely the acceptable mathematical manner of referring to such types of information. The information itself, as discussed above, may simply be a series of data points each indicative of a value of the metric and a time.

In a step 504, the values of the N metrics associated with the M ad entities may be compared, to evaluate a degree of similarity between the M ad entities based on their N metrics. Optionally, the comparing includes a many-to-many comparison between the M online ad entities over their N metrics, namely—a computing of N·M² statistical relationships, each being between a pair of historical time series. The pair is made up of (a) a historical time series pertaining to a certain metric of a certain ad entity, and (b) a historical time series pertaining to that certain metric of a different ad entity.

Generally, two types of comparisons may be possible in the framework of step 504. The first includes a comparison data point by data point, in which corresponding data points (namely, which are of the same time point) of one historical time series of a pair and the other historical time series of that pair are compared. The second includes applying a curve fitting algorithm, as known in the art, on each of the historical time series in the pair, to produce a pair of functions. These two functions may then be mathematically compared.

Optionally, the comparison of step 504 is a computation of a set of statistical relationships. Each of these statistical relationships may be between one first historical time series in a pair and the other historical time series in that pair. Merely as an example, the statistical relationships may be Pearson correlations, Spearman correlations, Kendall correlations, Kruskal correlations, wavelet coherences, Szekely distance correlations, etc., as known in the art. A further possible calculation is to sum the squares of difference of two time series in every time point. Using the Pearson correlations as an example now, they may refer to each historical time series in a pair as a whole; namely, it may provide insight as to the similarity of the entirety of the two historical time series in the pair. To this end, the time periods covered by these two historical time series may be the same (e.g. between Jan. 1, 2014 and Jan. 15, 2014). If these historical time series cover time periods which only partially overlap, they may undergo a preliminary step of truncating in order for them to include exactly the same time period.

Naturally, the larger N is, the more insight may be gained by benchmarking method 500. Namely, statistical relationships between a certain subset of the M ad entities may be more insightful if based on statistical relationships found between a larger number of metrics of members of this subset. As a simplistic example, a statistical relationship found between two ad entities based on a similarity between their impressions, conversions and CPC metrics, maybe highly more beneficial than a statistical relationship found between these two ad entities based on a similarity solely between their impressions metric. To this end, N may be an integer being as large as the number of metrics known in the field of online advertising.

In a step 506, based on the comparison of step 504, an N×M×M matrix may be constructed, which is indicative of statistical relationships between the M ad entities over their N metrics. The matrix may be stored in a computer memory (transient or non-transient) in a suitable data type, as known in the art.

In a step 508, the matrix may be clustered, so as to reveal implicit information hidden in it, namely—to produce multiple clusters each comprised of similarly-characterized cells. The clustering of the matrix may include sorting one or more of its dimensions in a specific order, such that the implicit information is revealed. In a simple, two-dimensional matrix, this means sorting its rows and/or columns. Multiple iterations of such sorting may be conducted, to iteratively enhance the clustering.

The clustering of step 508 may be performed using one or more cluster analysis methods known in the art. Examples include connectivity-based clustering, centroid-based clustering, distribution-based clustering, density-based clustering and more. See Wikipedia contributors, “Cluster analysis,” Wikipedia, The Free Encyclopedia, http://en.wikipedia.org/w/index.php?title=Cluster_analysis&oldid=598628819 (accessed Mar. 27, 2014), which is incorporated herein by reference.

A specific example of a suitable cluster analysis method is the one disclosed in Eisen et al., “Cluster analysis and display of genome-wide expression patterns”, in Proc. Natl. Acad. Sci. USA 1998, 14863-14868, which is incorporated herein by reference. Those of skill in the art will recognize that the “genes” of Eisen et al. are analogous to the ad entities of benchmarking method 500, and the “gene expressions” of Eisen et al. are analogous to the metrics of the benchmarking method. The output of the present clustering, when preformed in accordance with the method of Eisen et al., may be displayed graphically in a manner similar to the intuitive way Eisen et al. displays clustering and underlying gene expression data simultaneously.

Another specific example of a suitable cluster analysis method is the one disclosed in Robert L. Ling, “A computer generated aid for cluster analysis”, Communications of the ACM, vol. 16 issue 6, June 1973, pages 355-361, which is incorporated herein by reference. Generally, Ling discloses a computer generated graphic method, which can be used in conjunction with any hierarchical scheme of cluster analysis. The graphic principle used is the representation of the elements of a data matrix of similarities or dissimilarities by computer printed symbols (of character overstrikes) of various shades of darkness, where a dark symbol corresponds to a small dissimilarity. The plots, applied to a data matrix before clustering and to the rearranged matrix after clustering, show at a glance whether clustering brought forth any distinctive clusters. Ling's graphic method may be enhanced by enriching it with color, namely—the degree of similarity may be denoted as a color on a certain color scale, such as a transition from green to red, etc.

One advantageous clustering method of the matrix is hierarchical clustering. In the hierarchical clustering, the size of the matrix may be reduced, so as to combine multiple ones of the M ad entities and/or the N metrics hierarchically. Suitable software tools for hierarchically clustering the method include, to name a few examples:
Cluster 3.0, an open source tool which provides access to different clustering routines. See http://bonsai.hgc.jp/˜mdehoon/software/cluster.
ELKI (Environment for DeveLoping KDD-Applications Supported by Index-Structures) includes multiple hierarchical clustering algorithms, various linkage strategies and also includes the efficient SLINK algorithm, flexible cluster extraction from dendrograms and various other cluster analysis algorithms. See http://elki.dbs.ifi.lmu.de.
Octave, the GNU analog to MATLAB implements hierarchical clustering in linkage function. See http://www.gnu.org/software/octave.

The clusters produced by step 508, as discussed, are each comprised of similarly-characterized cells. The clusters may convey important insight to a user by indicating the nature of the ad entities and/or metrics associated with these clusters. For example, it may be indicated, for a cluster, that it pertains to ad entities in a certain business sector and/or to ad entities having other similar characteristics. Experimentation performed by the present inventors using large datasets of ad entities, has revealed that, in many occasions, clusters are formed of ad entities associated with a same business sector (e.g. retail, financial services, legal services, etc). In simple terms, this implies that ad entities of the same business sectors tend to behave the same, whereas ad entities of different business sectors tend to behave differently. This insight may be useful to a user who wishes to utilize a certain cluster as a joint benchmark to that user's own ad entitiy(ies). The user may select, as the joint benchmark, a cluster which pertains to the same or a related business sector of the user, hence making that joint benchmark highly relevant to the user's advertising activities. The cluster selected by the user may be backtracked, by examining the raw data which served to construct the matrix, to the ad entities which yielded that cluster. Then, the joint benchmark may be computed as a function of the pertinent metric(s) of those ad entities, such as a certain statistical measure of those pertinent metric(s) across the ad entities (e.g. average, mean, mode, etc.)

In a step 510, the matrix may be displayed graphically on a computer screen, indicating the results of the clustering of step 508. For example, strengths of the statistical relationships found between the M ad entities over their N metrics may be indicated, in the displayed matrix, numerically and/or using different colors. The similarly-characterized cells in the matrix, namely, may be visible to a user by recognizing regions of a same or a similar color and/or numbers.

Merely as one example, a color scheme for the matrix may be predetermined (or selected by a user), which includes a certain color (e.g. 255,0,0 on the RGB scale—namely red) for the weakest statistical relationship, and a certain color (e.g. 0,255,0 on the RGB scale—namely green) for the strongest statistical relationship. Then, each cell in the matrix may be filled with a color which extends between these two extremities, as suitable. For example, for a cell of some medium statistical relationship, the color may be olive—128,128,0 on the RGB scale.

A color scheme for the matrix may include more than two extreme colors. This may be useful, for example, for indicating a Pearson correlation: A first color may be used for the most negative correlation (−1), a second color for no correlation (0), and a third color for the most positive correlation (1).

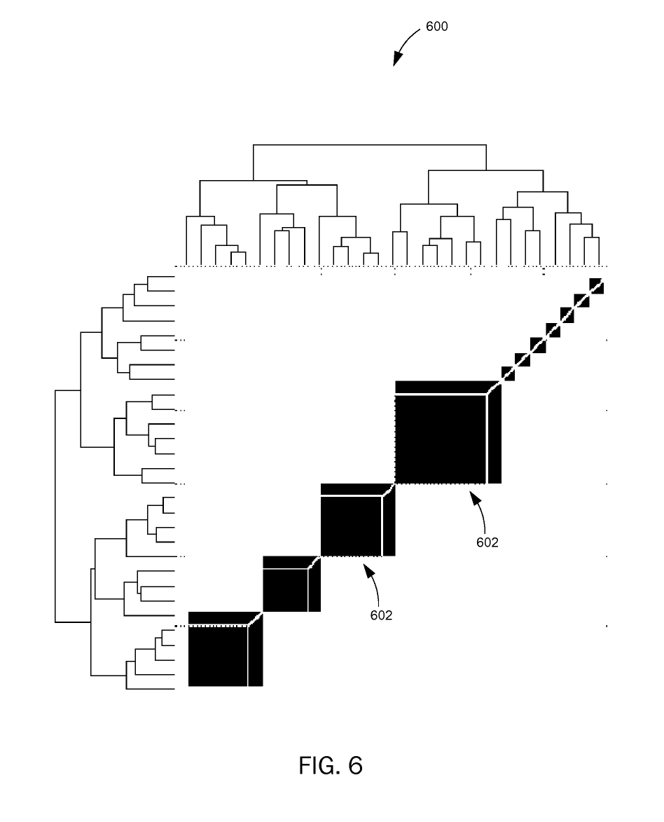

Reference is now made to FIG. 6, which shows an exemplary matrix 600 displayed graphically. The rows and columns of matrix 600 pertain to the ad entities compared, which are arranged hierarchically. Namely, not all ad entities are assigned a row and a column; rather, similar ad entities may be hierarchically nested, so as to minimize the size of matrix 600 and avoid repeating ad entities which are very similar to one another. As shown, the sorting of the dimensions of matrix 600 has revealed the existence of a number of clusters, such as clusters 602 and 604. Each of these clusters pertain to a metric of a number of ad entities. Hence, each such cluster may be referred to as a joint benchmark.

Referring now back to FIG. 5, a step 512 may include carrying out one or more automatic actions in an advertising platform, with respect to at least some of the ad entities. For example, the clustering may be used for communicating with an advertising platform which runs at least some of the ad entities, so as to restructure the way these ad entities are arranged in the advertising platform. For example, if these ad entities represent individual ads, these ads may be moved from their existing campaigns and grouped together in one or more new campaigns, in correspondence with the clustering of these ads. As another example, no new campaigns may be formed, but rather the ads may be shuffled between existing campaigns, to be clustered together in accordance with the clustering of method 500.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated.

What is claimed is:

1. A method for benchmarking in online advertising, the method comprising using at least one hardware processor for:
comparing values of a metric associated with a first online ad entity to values of the same metric associated with other online ad entities; and
based on the comparing, identifying one or more of the other online ad entities as potential benchmarks to the first online ad entity.

2. The method according to claim 1, wherein the comparing comprises:
receiving a first historical time series comprising the values of the metric associated with the first online ad entity;
receiving multiple other historical time series comprising the values of the metric associated with the other online ad entities; and
computing a set of statistical relationships, each of the statistical relationships being between the first historical time series and a different one of the multiple other historical time series.

3. The method according to claim 2, wherein the statistical relationships are Pearson correlations.

4. The method according to claim 2, wherein the identifying comprises:
based on the computing of the set of statistical relationships, selecting a specific one of the other online ad entities to serve as a potential benchmark to the first online ad entity,
wherein the selecting is upon determining that a strongest one of the statistical relationships is between the first historical time series and one of the multiple other historical time series which comprises the values of the metric associated with the specific one of the other online ad entities.

5. The method according to claim 2, wherein the identifying comprises:
based on the computing of the set of statistical relationships, selecting a specific subset of the other online ad entities to serve as a potential benchmark to the first online ad entity,
wherein the selecting is upon determining that strongest ones of the statistical relationships are between the first historical time series and the subset of the multiple other historical time series which comprises the values of the metric associated with the specific subset of the other online ad entities.

6. The method according to claim 5, further comprising:
computing a statistical measure of the values of the metric associated with the specific subset of the other online ad entities; and
defining the statistical measure as a benchmark to the values of the metric associated with the first online ad entity.

7. The method according to claim 6, wherein the statistical measure is selected from the group consisting of: an average, a mean and a mode.

8. The method according to claim 1, wherein the first online ad entity and the other online ad entities are each selected from the group consisting of: a campaign, a group of campaigns, an individual ads and a group of individual ads.

9. A computer program product for benchmarking in online advertising, the computer program product comprising a non-transitory computer-readable storage medium having program code embodied therewith, the program code executable by at least one hardware processor for:
comparing values of a metric associated with a first online ad entity to values of the same metric associated with other online ad entities; and
based on the comparing, identifying one or more of the other online ad entities as potential benchmarks to the first online ad entity.

10. The computer program product according to claim 9, wherein the comparing comprises:
receiving a first historical time series comprising the values of the metric associated with the first online ad entity;
receiving multiple other historical time series comprising the values of the metric associated with the other online ad entities; and
computing a set of statistical relationships, each of the statistical relationships being between the first historical time series and a different one of the multiple other historical time series.

11. The computer program product according to claim 10, wherein the statistical relationships are Pearson correlations.

12. The computer program product according to claim 9, wherein the identifying comprises:
based on the computing of the set of statistical relationships, selecting a specific one of the other online ad entities to serve as a potential benchmark to the first online ad entity,
wherein the selecting is upon determining that a strongest one of the statistical relationships is between the first historical time series and one of the multiple other historical time series which comprises the values of the metric associated with the specific one of the other online ad entities.

13. The computer program product according to claim 9, wherein the identifying comprises:
based on the computing of the set of statistical relationships, selecting a specific subset of the other online ad entities to serve as a potential benchmark to the first online ad entity,
wherein the selecting is upon determining that strongest ones of the statistical relationships are between the first historical time series and the subset of the multiple other historical time series which comprises the values of the metric associated with the specific subset of the other online ad entities.

14. The computer program product according to claim 13, wherein the program code is further executable by the at least one hardware processor for:
computing a statistical measure of the values of the metric associated with the specific subset of the other online ad entities; and
defining the statistical measure as a benchmark to the values of the metric associated with the first online ad entity.

15. The computer program product according to claim 14, wherein the statistical measure is selected from the group consisting of: an average, a mean and a mode.

16. The method according to claim 9, wherein the first online ad entity and the other online ad entities are each selected from the group consisting of: a campaign, a group of campaign, an individual ads and a group of individual ads.

17. A method for benchmarking in online advertising, the method comprising using at least one hardware processor for:
comparing values of N metrics associated with M online ad entities, wherein N≧1 and M≧2;
based on the comparing, constructing an N×M×M matrix indicative of statistical relationships between the M online ad entities over the N metrics; and
clustering cells of the matrix, to produce multiple clusters each comprised of similarly-characterized cells, whereby each of the multiple clusters is usable as a joint benchmark.

18. The method according to claim 17, wherein different ones of the multiple clusters are associated with advertisers belonging to different business sectors.

19. The method according to claim 17, wherein the comparing comprises:
receiving multiple historical time series comprising the values of the N metrics associated with the M online ad entities; and
computing N·M² statistical relationships, each of the statistical relationships being between members of a different pair of the multiple historical time series.

20. The method according to claim 19, wherein the statistical relationships are Pearson correlations.

21. The method according to claim 17, wherein N≧2.

22. The method according to claim 17, wherein N≧3.

23. The method according to claim 17, further comprising using the at least one hardware processor for displaying the matrix on a computer screen, wherein strengths of the statistical relationships are displayed numerically.

24. The method according to claim 17, further comprising using the at least one hardware processor for displaying the matrix on a computer screen, wherein strengths of the statistical relationships are displayed using different colors.

25. A computer program product for benchmarking in online advertising, the computer program product comprising a non-transitory computer-readable storage medium having program code embodied therewith, the program code executable by at least one hardware processor for:
comparing values of N metrics associated with M online ad entities, wherein N≧1 and M≧2;
based on the comparing, constructing an N×M×M matrix indicative of statistical relationships between the M online ad entities; and
clustering cells of the matrix, to produce multiple clusters each comprised of similarly-characterized cells, whereby each of the multiple clusters is usable as a joint benchmark.

26. The computer program product according to claim 25, wherein different ones of the multiple clusters are associated with advertisers belonging to different business sectors.

27. The computer program product according to claim 25, wherein the comparing comprises:
receiving multiple historical time series comprising the values of the N metrics associated with the M online ad entities; and
computing N·M² statistical relationships, each of the statistical relationships being between members of a different pair of the multiple historical time series.

28. The computer program product according to claim 27, wherein the statistical relationships are Pearson correlations.

29. The computer program product according to claim 25, wherein N≧2.

30. The computer program product according to claim 25, wherein N≧3.

31. The computer program product according to claim 25, wherein the program code is further executable by the at least one hardware processor for displaying the matrix on a computer screen, wherein strengths of the statistical relationships are displayed numerically

32. The computer program product according to claim 25, wherein the program code is further executable by the at least one hardware processor for displaying the matrix on a computer screen, wherein strengths of the statistical relationships are displayed using different colors.
